(19) United States
(12) Patent Application Publication
(10) Pub. No.: US 2014/0115950 A1
(43) Pub. Date: May 1, 2014

(54) APPARATUS AND METHOD FOR SAFE INSECT EXTERMINATION

(71) Applicant: T. Eric Chornenky, Carmichaels, PA (US)

(72) Inventor: T. Eric Chornenky, Carmichaels, PA (US)

(21) Appl. No.: 14/064,332

(22) Filed: Oct. 28, 2013

Related U.S. Application Data
(60) Provisional application No. 61/718,973, filed on Oct. 26, 2012.

(51) Int. Cl. A01M 1/22

(52) U.S. Cl. CPC A01M 1/223
USPC 43/132.1

(57) ABSTRACT

The invention provides an apparatus and method for exterminating insects using at least a pair of spaced apart electrodes mounted within or on a supporting member, while preventing electric shock hazards to humans, household pets and animals. The electrodes are spaced apart in either horizontal or vertical planes. Optional capacitance sensor may be employed to selectively activate or deactivate the apparatus. The invention further provides means to maintain effectiveness by using redundant electrode pairs coupled to the same or unique voltage if one pair of electrodes is rendered inoperable due to the presence of an electrocuted insect across it or by providing an automatic collection means using a small vehicle or a notification signal to notify a human or robotic vacuum cleaner that collection is needed.

### CROSS-REFERENCE TO RELATED APPLICATIONS

This application is related to and claims priority from U.S. Provisional Patent Application Ser. No. 61/718,973 filed on Oct. 26, 2012.

### FIELD OF THE INVENTION

The present invention relates, in general, to insect and rodent extermination and, more particularly, this invention relates to apparatus and method for safe yet effective insect and rodent extermination in a manner substantially preventing hazards to humans, household pets and animals.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

As is generally well known, insect or bug infestation in dwellings or farm enclosures poses health risk to occupants. Prior to the conception and development of the instant invention, efforts have been made to exterminate insects or rodents by subjecting them to high voltage. However, further improvements are required, particularly in the area of preventing hazards to humans, household pets and animals.

### SUMMARY OF THE INVENTION

The invention provides an apparatus and method for exterminating insects while substantially preventing electric shock hazards to humans, household pets and animals.

In one embodiment, the apparatus comprises a support member including a base portion and another portion extending from the base portion; and electrodes mounted on or in a surface of the each base portion and the another portion of the support member and electrodes connectable to a source of electric power, the electrodes are mounted an sized so as to cause the insects bridging the electrodes to receive a current when the electrodes are connected to the source of electric power.

In another embodiment, the apparatus comprises a support member having a pair of generally planar surfaces spaced apart from each other to define thickness of the support member; and electrodes connectable to a source of electric power and disposed in pairs with a unique spacing therebetween on a surface or within a thickness portion of the member, the unique spacing is configured so as to cause the insects bridging any pair of electrodes to receive a current as a function of their internal resistance when the electrodes are connected to the source of electric power.

In a further embodiment, the apparatus comprises a support member that includes a base portion having a pair of generally planar surfaces spaced apart from each other to define thickness of the base portion, a cap portion having a concave inner surface spaced apart from an inner surface of the base portion and a convex outer surface defining each of a thicker middle region and a pair of generally thin outer edge regions of the cap portion, and a middle portion disposed mediate the base and cap portions along length thereof, the middle portion being sized so as to position each of the pair of outer edges of the cap portion at a distance away from the inner surface of the base portion. The apparatus further includes a pair of electrodes connectable to a source of electric power, the pair of electrodes being disposed in a spaced apart relationship with each other on a surface or within a thickness portion of the support unitary one-piece member, the spaced apart relationship is so configured as to cause the insects bridging the pair of electrodes to receive a current as a function of their internal resistance when the pair of electrodes are connected to the source of electric power. The distance is sufficiently sized so as to permit insects to reach the pair of electrodes and prevent insects from climbing onto the exterior surface of the cap portion. The apparatus is configured to at least substantially prevent or eliminate direct contact of humans, household pets and animals with the pair of electrodes.

### OBJECTS OF THE INVENTION

It is, therefore, one of the primary objects of the present invention to provide an apparatus for safe insect extermination.

Another object of the present invention is to provide an apparatus for safe insect extermination that employs electrical electrodes connected to high voltage and means for at least partially shielding electrical electrodes from direct view or access.

Yet another object of the present invention is to provide an apparatus for safe insect extermination that employs electrical electrodes connected to high voltage and a capacitance based sensing arrangement to discern between insects, humans, pets and animals.

A further object of the present invention is to provide an apparatus for safe insect extermination that employs electrical electrodes connected to high voltage and a motion based sensing arrangement to discern between insects, humans, pets and animals.

Yet a further object of the present invention is to provide an apparatus for safe insect extermination that employs electrical electrodes connected to high voltage and a resistance based sensing arrangement to discern between insects, humans, pets and animals.

An additional object of the present invention is to provide an apparatus for safe insect extermination that employs electrical electrodes connected to high voltage and means to accommodate small to large insects.

Yet a further object of the present invention is to provide an apparatus which remains effective after an insect has been exterminated and not removed yet continuing to engage some of the electrical electrodes.

Another object of the present invention is to provide an apparatus for safe insect extermination that will limit the number of repeated spark electrical discharges to a predetermined number to minimize human awareness of such events, especially in a home setting at night.

An additional object of the present invention is to provide an apparatus for safe insect extermination that is capable of automatically notifying for collection or collecting the remains of any exterminated insects thereby maximizing continuing effectiveness while also reducing or eliminating the need for human intervention and overall human awareness which many may deem to be unpleasant.

Another object of the present invention is to provide an apparatus for safe insect extermination that employs electrical electrodes connected to high voltage and means for securing such apparatus to various surfaces.

A further object of the present invention is to provide a method for safe insect extermination utilizing the above described apparatus.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is one diagrammatic end elevation view of the apparatus for safe insect extermination;

FIG. 2 is another diagrammatic end elevation view of the apparatus for safe insect extermination;

FIG. 3 is yet another diagrammatic end elevation view of the apparatus for safe insect extermination;

FIG. 4 is a further diagrammatic end elevation view of the apparatus for safe insect extermination;

FIG. 5 is yet a further diagrammatic end elevation view of the apparatus for safe insect extermination;

FIG. 6 is a further diagrammatic end elevation view of the apparatus for safe insect extermination;

FIG. 7 is yet a further diagrammatic end elevation view of the apparatus for safe insect extermination

FIG. 8 is one diagrammatic environmental view using the apparatus of FIGS. 1-5;

FIG. 9 is another diagrammatic environmental view using the apparatus of FIGS. 1-5;

FIG. 10 illustrates one example of a voltage conversion, multiplication and control circuit, including inputs from a variety of safety sensors;

FIG. 11 illustrates an embodiment for determining the max spark gap size which determines voltage based on the bug species expected max body length and leg length/walking height characteristics;

FIG. 12 illustrates an upside down configuration that requires additional features for effectiveness for all insects, except those with extremely short legs or strong legs;

FIG. 13 illustrates a diagrammatic end view of an embodiment using several sized electrodes with insulating barriers;

FIG. 14 illustrates a diagrammatic end elevation view of an upside down configuration with a shield to catch falling dead insects;

FIG. 15 illustrates an approximation of new virtual spark gap distance calculation based on the geometry of the electrode separation and insulating barrier height;

FIG. 16 illustrates an alternative means to using insulating barriers and higher voltages in killing long legged insects or medium length upside down insects by using conductive electrodes of varying heights;

FIG. 17 illustrates a flowchart of an exemplary method to control activation or deactivation of electrodes;

FIGS. 18a-b illustrate front and end elevation views of an optional device to dislodge dead insects from contact with electrical electrodes;

FIG. 19 shows a an environmental view of employing any above apparatus in a doorway;

FIG. 20 illustrates a partial plan view of an embodiment including electrodes affixed on a male Velcro® backed flat strip so as to adhere to a wall or ceiling or also attaching better to a rug on the edges;

FIG. 21 illustrates a need for gap between electrodes and voltage to be sized to accommodate bug size and shows insects of a three different sized and further applying a 20%-80% rule;

FIG. 22 illustrates a diagrammatic end elevation view of an arrangement of staggered positive electrodes configured for and coupled to different voltages so as to electrocute all size insects in the mushroom shape;

FIG. 23 illustrates a diagrammatic end elevation view of an alternative embodiment of T-shaped extruded member having a plurality of electrodes mounted in a vertical direction and sized with different voltages so as to accommodate insects of different sizes;

FIG. 24 illustrates a diagrammatic end elevation view of one form of the invention, particularly illustrating an arched configuration of the base member with electrode arrangement of FIGS. 22-23; and

FIG. 25 illustrates a diagrammatic end elevation view of another form of the invention, particularly illustrating an L-shaped configuration of the base member with electrode arrangement of FIGS. 22-23.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of an insect applies but is not limited to ants, bed bugs, cockroaches, spiders, centipedes and the like insects or similar small crawling creatures. However, the device could easily be scaled up to be effective against larger pests such as cold-blooded scorpions, snakes or even small warm blooded rodents.

The present invention describes an apparatus and method for safe insect extermination in a manner substantially preventing hazards to humans, household pets and animals, such as horses, cows, sheep, goats, pigs, chickens, turkeys and the like.

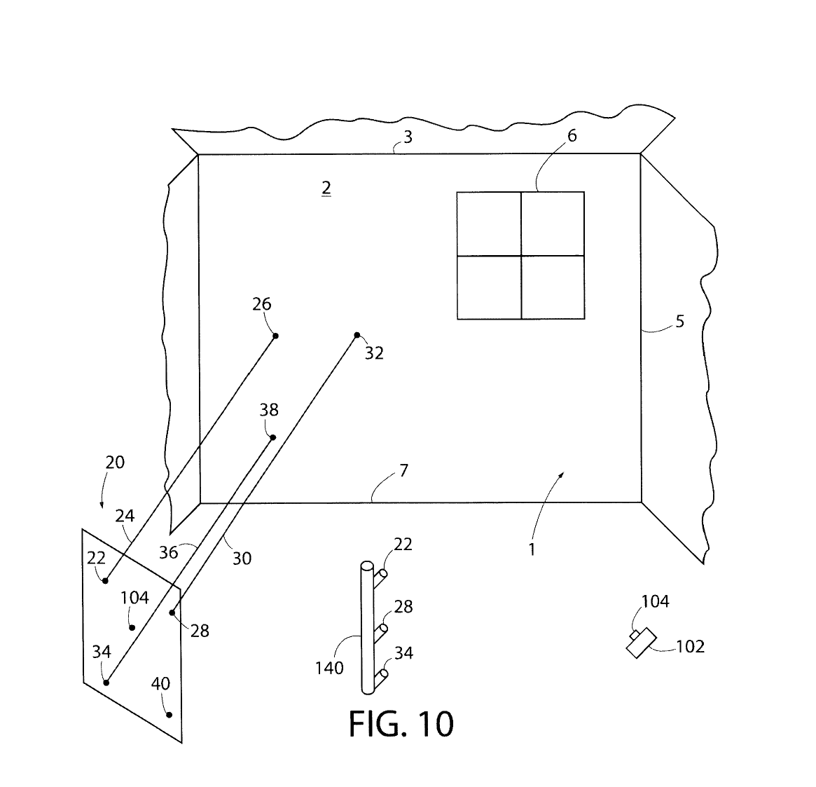

The apparatus, generally designated as 10, of the instant invention is based on a principle of providing at least a pair of electrodes 12, 14 in electrical communication with a power source 104. The power source 104 may be provided as a source of high voltage (HV), preferably of direct current (DC) type, which could be powered by using an alternative current (AC) to DC voltage converter, connected to a conventional wall plug, or any other suitable devices or systems, which is then connected to a high voltage DC converter. The high voltage is preferred to develop sufficient voltage to jump the air gap if insect 2 is not in contact with both electrodes 12, 14 but only near one or both the electrodes, while also developing sufficient current to electrocute the insect 2. Also, an insect's relatively insulating exoskeleton has a high resistance while the lower resistance organs inside underneath are the ones needing to be affected. When the apparatus 10 is to be operated from low DC voltage or battery, an optional DC-DC converter will be also provided. In both cases the low DC voltage higher current is converted to HV, low current using a high voltage DC converter including an oscillator 108, transformer 110 and voltage multiplier 112, as best shown in FIG. 10. The power source 104 in turn powers electrodes 12, 14 which are so positioned in a spaced apart relationship to each other that the insect 2 bridging near the electrodes 12, 14 will receive a current as a function of its internal resistance and a spark gap discharge through air characteristics. The amount of voltage and/or current limit is set to exterminate or repeal the insect 2.

One of the electrodes, reference with numeral 12 is electrically coupled to ground, while the second electrode 14 is coupled to positive voltage or negative voltage of the power source 104. Although, the electrodes 12, 14 are illustrated as having a rectangular cross-section, any conventional cross-sections are contemplated. Furthermore, electrodes 12, 14 are preferably identical in size.

As it will be explained further in this document, the instant invention provides means to at least substantially reduce if not completely eliminate electrical shock hazards to humans, household pets and animals during operation of the apparatus 10 to either exterminate or repeal insects 2.

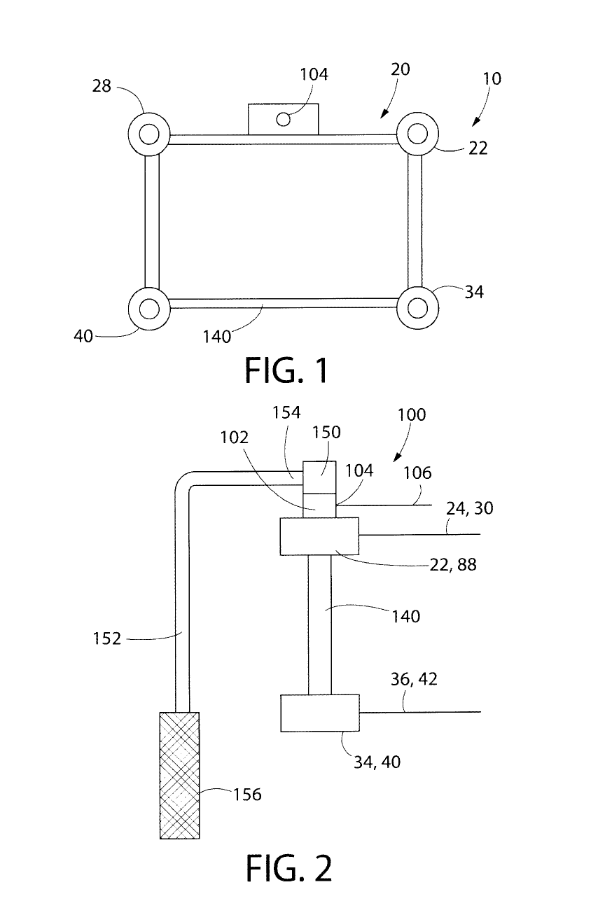

The instant invention contemplates that the electrodes 12 and 14 are mounted on a surface or within the thickness of a member. In accordance with one forms of FIGS. 1-4, the apparatus 10 (illustrated in a side view of a typically extrusion-based construction), includes a support member, generally designated as 30, which is preferably provided as an support member. Specifically, the support member 30 includes a base portion 32 having a pair of generally planar surfaces 34, 36 spaced apart from each other to define thickness of the base portion 32. Support member 30 also includes a cap portion 40 preferably having a concave inner surface 42 spaced apart from an inner surface 34 of the base portion 32 and a convex outer surface 44 defining each of a thicker middle region 46 and a pair of generally thin outer edge regions 48 of the cap portion 40 that may converge to a sharp edge 49, as referenced in FIG. 1. The cap portion 40 is typically at least one or flexible and resilient. The advantage of such cross-sectional shape of the cap portion 40 is in both hiding any exterminated insects from human view and providing a protection means from the high voltages should a human or pet step on the apparatus, especially in bare feet and/or at night.

Now in a particular reference to FIG. 2, the cap portion 40 may include at least one aperture 50 formed through a thickness thereof, preferably inclined at an angle relative to the inner surface 34 of the base portion 32. The inclined orientation of the aperture 50 is advantageous for viewing inside the apparatus from overtop to verify if exterminated pests are present and cleaning is needed.

Either form of FIGS. 1-4, also includes a middle portion 60 disposed mediate the base and cap portion, 32 and 40 respectively along an entire length thereof. The middle portion 60 is sized so as to position each of the pair of outer edges 48 of the cap portion 40 at a distance 62 away from the inner surface 34 of the base portion 32. The middle portion 60 may include at least one aperture 64 formed through a thickness thereof 64 that may possibly be screened on one or both sides with screens 65 to allow air flow while preventing tiny bugs from passing through it.

The distance 62 is sufficiently sized so as to permit insects 2 to reach electrodes 12, 14 and prevent insects 2 from climbing onto the exterior surface of the cap portion 40. The distance 62 is further sufficiently sized, configuring the apparatus 10, to at least substantially prevent or eliminate direct contact of humans, household pets and animals with electrodes 12, 14. As it was described above, the electrodes 12, 14 are either disposed on the inner surface 34 of the base portion 32 or embedded into the thickness of the base portion 32, as best shown in FIG. 1. It is anticipated that the high voltage level will be sufficient to discharge from the electrodes 12, 14, through the insulating material of the base and through the air gap above the electrodes 12, 14 and through the insect 2 between the electrodes 12, 14. It is also anticipated that the high voltage will not be sufficient to bridge the air gap if a conductive insect 2 is not present. As is further shown in FIG. 1, the electrodes 12, 14 are disposed to one side of the middle portion 50 and the apparatus 10 may further include another pair of electrodes 12, 14 disposed to an opposite side of the middle portion 60.

Now in a particular reference to FIG. 4, it is also contemplated for the middle portion 60 to include a channel 70 extending a length of the middle portion 60 in open communication with one surface 64 thereof and wherein each of the pair of electrodes 12, 14 is positioned at a juncture of the surface 64 of the middle portion 60 and a wall 72 of the channel 70.

Furthermore, it is also contemplated for the middle portion 60 to include a pair of channels 70 extending a length of the middle portion 60 in open communication with a respective surface 64, 66 thereof, wherein the apparatus 10 further includes an additional pair of electrodes 16, 18 and wherein each electrode is positioned at a juncture of the respective surface 64, 66 of the middle portion 60 and one wall 72 of a channel 70.

Preferably, the support member 30 is configured as a unitary, one-piece member. For example, an extrusion is seen as practical here.

However, the instant invention contemplates for the apparatus 10 to include means, generally designated as 80, for releaseably connecting the middle portion 60 to the base portion 32. This can be used for cleaning purposes, to more easily clean dead insects 2 or to allow for close visual inspection and verification of the number, type, size or presence of dead insects 2 not visible normally from above. Now in further reference to FIG. 2, such means 80 may include an incongruity or abutment 82 disposed on an end of the middle portion 60 along a length thereof and a channel 84 formed in the inner surface 34 of the base portion 32 in open communication thereof, the channel 84 being configured to releaseably receive the abutment 82 therewithin. The means 80 may also include incongruities (not shown) disposed on an end of the middle portion 60 and receptacles (not shown) formed in the inner surface 34 of the base portion 32 in open communication thereof, the receptacles being configured to releaseably receive the incongruities. In other words, it is not necessary for the incongruity or abutment 82 and the channel 84 to be in a continuous form along the length of the base 32. It would be understood that the abutment 82 may be provided on the surface 32 of the base 30 while the middle portion 60 is configured with the channel 84.

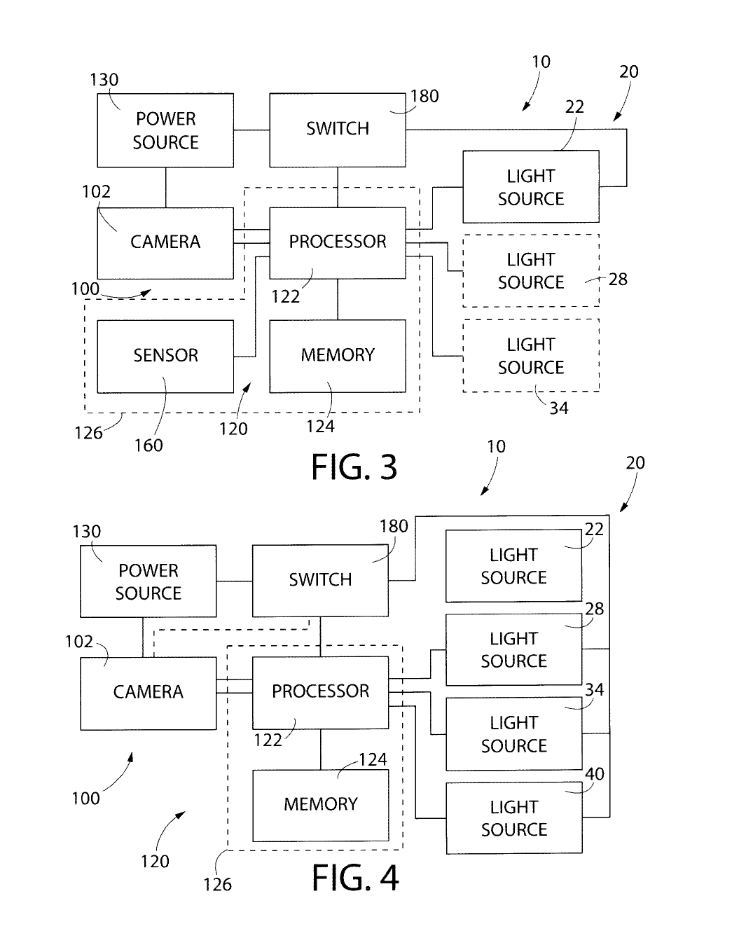

Now in a particular reference to FIGS. 3-4 and 10, the apparatus 10 may further include optional means, generally designated as 90, for detecting presence of humans, household pets or animals. In accordance with one form of the invention, the presence detection means 90 is a sensor 92 positioned on the support member 30. For example, such sensor 92 may be one or more of conductive strips or wires connected to a capacitance or proximity measuring circuit. In accordance with another form of the invention, the presence detection means 90 is a sensor 94 positioned in a sufficient proximity to the support member 30. Such sensor 94 may be a motion detector properly aimed at support member 30, such as a Passive Infrared Detector (PIR) similar to those used in security devices for burglar or intrusion detection. As a safety precaution, the presence detection means 90 may also include a ground fault sensor 96. The above described sensors provide input to a controller 120, which could be of a microprocessor type, capable of executing a predetermined logic algorithm.

Electrodes 12, 14 may be also coupled to the controller 120 through a voltage clamp 122. For the reasons to be explained later, a timer 124 is also provided, although it can be integrated into the circuit of the controller 120.

Optional visual indicator 126 and an audible alarm 128 may be also provided to either annunciate operating or non-operating condition of the above described apparatus.

The instant invention also guards against inadvertent exposure of humans or household animals to voltage discharge through electrodes 12 and 14. By way of one example, of FIGS. 3-4, the capacitance or proximity sensors 92 are configured to discern, either alone or in combination with a control logic, between insects 2 and fingers or objects, such as knifes or toys, passing therethrough. One way to sense this is through a sudden change in capacitance, the profile of capacitance change over time, for example. An insulating object would typically have a higher dielectric constant, increasing capacitance. A conductive object would decrease the effective gap distance and also increase the capacitance. When a body of the insect 2 initially passes between sensors 92, the capacitance increases, though typically not as much as from a human finger, but it may be enough to trigger the capacitance sensing control circuit to turn the HV OFF. Once the insect 2 passes past the sensors 92, the capacitance would decrease, causing the capacitance sensing circuit to turn the HV back ON and reconnect HV to electrodes 12 and 14, thus allowing the insect 2 to be killed when it sufficiently nears the gap between electrodes 12 and 14.

A time domain reflectometer or multi-frequency capacitance measuring means may further be used to improve insect versus non-insect object detection, but would be more expensive. By way of another example of FIG. 4, the cap portion 40 and the middle portion 60 are substantially flexible so that a force onto the cap portion 40, for example from a person stepping on it, would generate increased capacitance between sensors 92 sufficient to trigger a disconnect of power supply to the electrodes 12, 14. It would also serve to short out electrodes 12, 14 or decrease the spark gap sufficiently to cause discharge between them, reducing or eliminating the voltage or current danger should human or animal flesh come near the electrodes which may have caused the distortion in the first place. This acts as a second safety feature.

As is further illustrated in FIG. 3, the power supply 104 and even the power jack 102 may be imbedded into the thickness or thicknesses of the support member 30. Furthermore, any conventional fastening means 130, such as adhesives, adhesive tapes, and fasteners, including hook and loop types, are contemplated for either releaseably or permanently attaching the apparatus 10 to a surface. Furthermore, an optional mounting member 38, for example a channel in FIG. 4, may be provided so as to attach the support member 30 to a surface.

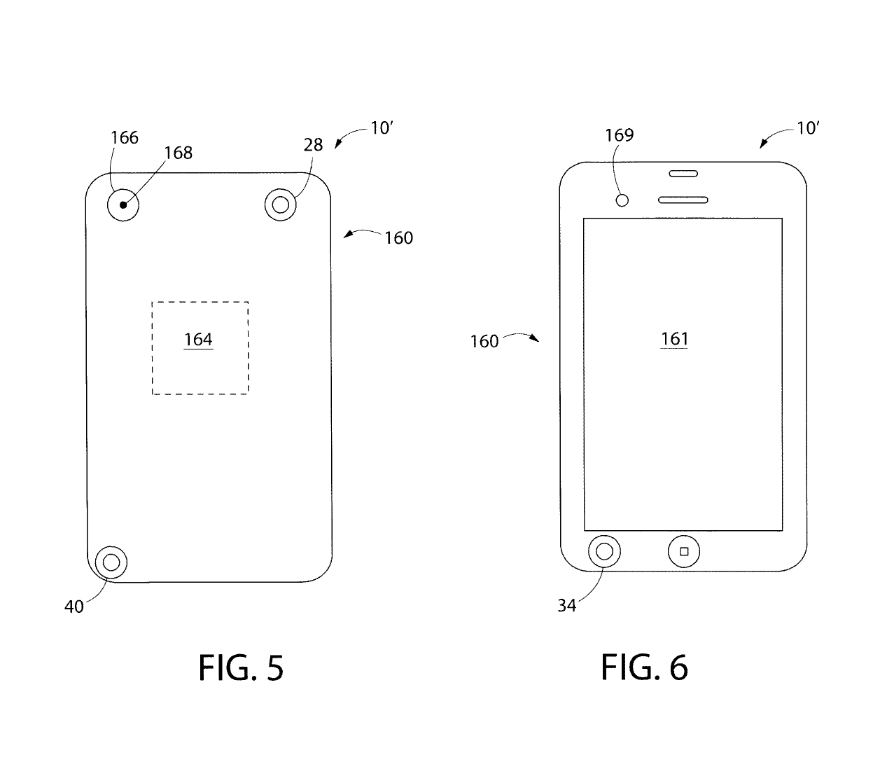

Now in a particular reference to FIGS. 5-6, and in accordance with another embodiment, the instant invention provides an apparatus, generally designated as 180, comprising an support member 190 having a pair of generally planar surfaces 192, 194 spaced apart from each other to define a thickness of the support member 190. For the sake of clarity, the reader is advised that only a width of the support member 190 is represented in these figures. It is also contemplated that the upper surface 192 may be a curved surface. Electrodes 12, 14 are provided and are connectable to a source of HV electric power, the pair of electrodes 12, 14 being disposed in a spaced apart relationship with each other on the surface 192 or within a thickness portion of the member 190. The spaced apart relationship between the pair of electrodes 12, 14 is configured so as to cause the insect 2, being close to or bridging the pair of electrodes 12, 14, to receive a current from the pair of electrodes 12, 14 which are connected to the source of HV electric power. The internal resistance of the insect 2 is low compared to other factors including air discharge characteristics and internal resistance of the circuit, power supply capacitors, etc.

There is also a sensor 92, for example of a capacitance sensing type, positioned to detect presence of insects, humans, household pets and animals, depending on the capacitance and capacitance change versus time change or a proximity threshold criteria chosen and electrode surface area and configuration. An insect 2 is seen as a pair of conductive plates between electrodes 12 and 14, i.e. a plate between electrode 12 and the insect and a plate between the insect 2 and electrode 14. The inner flesh of the insect 2 is sufficiently conductive to connect the plates electrically for capacitance measurement purposes even through the insects insulating exoskeleton exterior.

The apparatus 10 may further include at least one other pair of electrodes 16, 18 positioned next to the pair of electrodes 12, 14 in a spaced apart relationship being different than the spaced apart relationship of the electrodes 12, 14 so as to accommodate insects 2 of various lengths. Additionally, a fastener 130, such as a male or female Velcro® hook portion may be disposed on the opposite surface 194 of the member 110 for attaching apparatus 10 to a carpet like surface or to a piece of fuzzy female Velcro® pre-attached to a wall. Fastener 130 may be also provided as an adhesive or adhesive tape for attaching the apparatus 100 to a smooth surface. Additionally, Velcro® fastener may be provided with a peelable cover 132.

The invention contemplates that the second pair of electrodes 12 and 14 plays an important role when the insect 2 is exterminated by the current from the first pair of electrodes 12 and 14 and renders them inoperable to exterminate additional insects 2 due to bridging between the pair of electrodes 12 and 14 by lifeless body of the insect 2. In this situation, the second pair of electrodes 12 and 14 will remain functioning for another insect 2, even while the first pair of electrodes remains inoperable for a period.

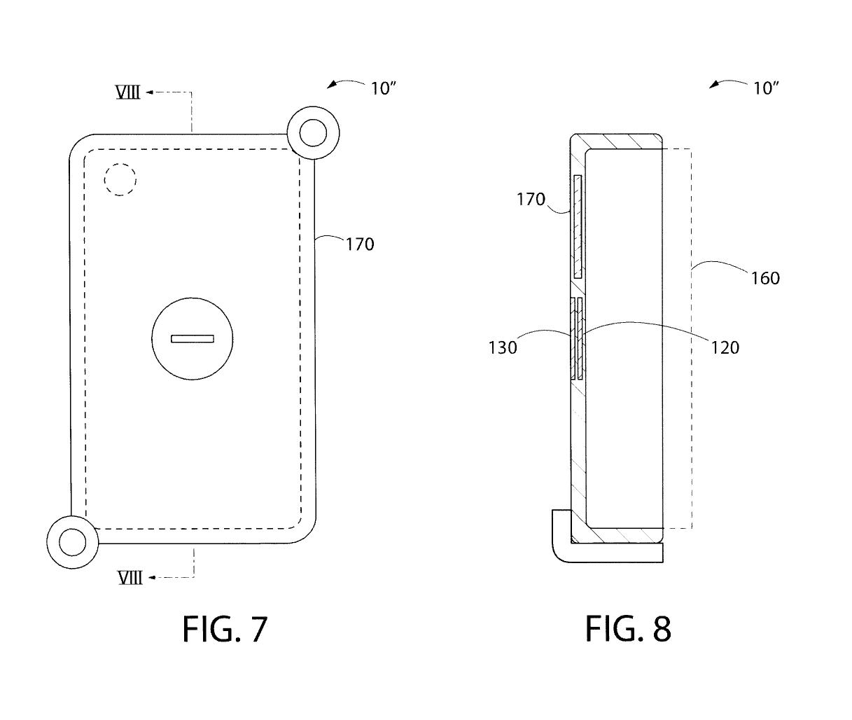

Now in a particular reference to FIG. 7, and in accordance with yet another embodiment, the instant invention provides an apparatus, generally designated as 200, comprising an support member 210 including a generally planar base surface 212, a first side surface 214 inclined relative to the base surface 212, a second side surface 216 inclined relative to the base surface 212, a first pair of pair of electrodes 12, 14 connectable to a source of electric power, the first pair of electrodes 12, 14 being disposed in a first spaced apart relationship with each other on the first surface 212 or within a thickness portion of the member 210 in close proximity to the first surface 212, the first spaced apart relationship is so configured as to cause the insects 2 bridging or being sufficiently near the first pair of electrodes 12, 14 to receive a current when the first pair of electrodes 12, 14 are connected to the source of electric power. There is also a second pair of pair of electrodes 16, 18 connectable to a source of electric power, the second pair of electrodes 16, 18 being disposed in a second spaced apart relationship with each other on the second surface 214 or within a thickness portion of the member 210 in close proximity to the second surface 214, the second spaced apart relationship is so configured as to cause the insects 2 bridging or being sufficiently near the second pair of electrodes 16, 18 to receive the current when the second pair of electrodes 16, 18 are connected to the source of electric power.

The apparatus 200 may further include an abutment 230 upstanding on a juncture of the first and second side surfaces, 212 and 214 respectively, the abutment 230 being configured to facilitate movement of insects 2 (prevent their falling down to one side or the other and not dying in the middle and continuing to short out the gap between 12 and 16) received the current from the first and second side surfaces, 212 and 214 respectively. Additionally, a hollow aperture 240 may be formed through a length of the member 210 to reduce weight and cost of the support member 210 and, if required, allow flexibility of the walls carrying side surfaces 212 and 214.

Although not shown, the above described fastener 130 is contemplated herein.

FIG. 8 illustrates one environmental top view of the apparatus 10 used in a combination with a bed 4. Preferably, the apparatus 10 completely surrounds the bed 4 so as to prevent insect infiltration from all four sides, including the side of the bed 4 adjacent to the wall 6. Essentially, the apparatus 10 provides a shield barrier around the bed 4. The apparatus 10 may be connected to the wall plug by way of an AC-DC converter 100. FIG. 8 also shows a pair of sensors 94 positioned to sense movement of humans from either side of the bed 4 and may be further installed to sense movement of the humans from the end of the bed 4. It will be also understood that other objects and/or structures can be protected by the above described shield/barrier concept.

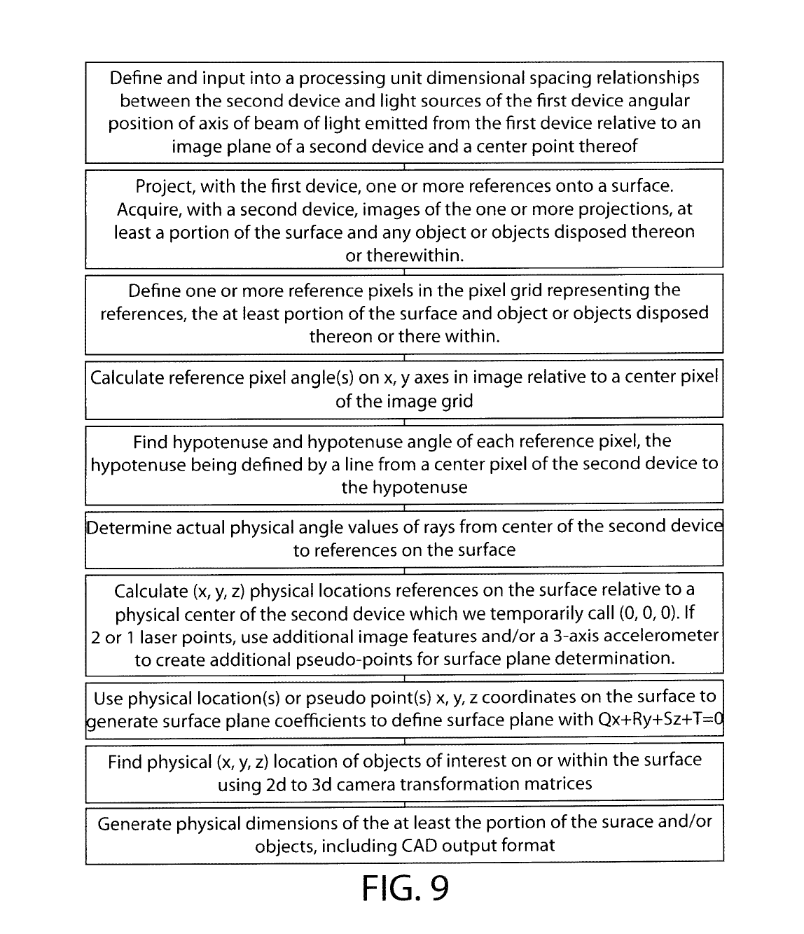

FIG. 9 illustrates another environmental view of the apparatus 10 used in a combination with a door frame 9 with the apparatus 10 being mounted at the bottom of the door frame 9. At least one vertical portion 10′ on one or both sides is also contemplated. The height of the vertical portion 10′ is selected depending on the climbing behavior of insect species to be exterminated. An optional handle 98, or the like means, may be used for ease of removal of the apparatus 10. Although, the vertical portion 10′ extends a portion of the door frame 9, it may be extended to upper edge thereof. The concept of the vertical portion 10′ may be also applied in the embodiment of FIG. 9 so as to exterminate insects 2 in two or more planes. More specifically, it would be understood, that the vertical portion 10′ may be mounted on both side of the bed 4 so as to shield the bed 4 from the insects 2 crawling on a vertical wall.

The instant invention contemplates that the any apparatus 10, 180 or 200 may include a built in electric jack or electric connection 102 for connecting apparatus 10, 180 or 200 to source of power. A second jack 102 may be daisy chained in parallel to allow the low voltage DC power to pass through to a second unit and power it similarly. This may be a male jack allowing the units to connect when abutted together, or allowing an attachable low-voltage extension cord to power another nearby unit. In other words, several lengths of the apparatus 10, 180 or 200 may be joined together to form a longer overall length. Furthermore, it is contemplated, that the LV to HV power conversion device 104 is also embedded within the apparatus 10, 180 or 200, for example in the thicker region 46 of the apparatus 10 of FIG. 3.

Now in reference to FIG. 10, therein is illustrated an electrical control circuit, including the power source 104 that includes the oscillator 108, step-up transformer 110 (preferably also a sufficiently isolating transformer to withstand the HV, preventing unsafe current leakage between the HV secondary an low voltage primary windings), and voltage multiplier 112. The power source 104 is directly connected to the power jack 102 and then to the wall voltage converter 106.

In operation, the initial standard 120 vac from the common AC power source is converted, at the converter 106, to 3 v, 6 v or 12 v DC. Then, through preferably a thin wire capable of carrying about 1 amp, for example such as a two-electrode speaker wire, the converter 106 is connected to the jack 102 on the apparatus 10 and then into the HV power transformer 110 and voltage multipliers 112 that multiplies the above voltages up to 300 v, 600 v, 1500 v, 3000 v depending on the electrodes 12, 14, 16, 18, gap length therebetween and allowable voltage level calculated before/below undesirable self-discharge through air without presence of the insect 2. The voltage multiplier circuit 112 may be constructed using common capacitors and diodes ladder circuit which is advantageous for embedding into the thickness of the support member.

A low current oscillator 108 would take the 3 v DC and convert it to AC voltage for input into a low current step up transformer 110, which for example may boost it up to 150 vac.

FIG. 10 also shows safety accommodations within the control circuit related to sensor input data from a variety of sources, and controls such as ON/OFF switch 101 and the HV DC output to electrodes 12 and 14. Also shown, are the visual indicator 126 and audible indicator or alarm 128.

PIR 94 is aimed at the electrodes 12 and 14. Ground Fault Detector Sensor 96 is attached to the HV outputs and ground or other power circuit areas to enable detection of a ground fault. The capacitance or proximity sensor 92 is connected to optional conductive strips on the device to sense capacitance changes allowing discrimination between humans/pets and insects. One method of detecting capacitance change between separate flat conductive parallel electrode strips 12, 14 is to use the flesh as a electrode, forming a 2nd and 3rd plate between strip #1 and flesh and flesh to strip #2.

The circuit may also include an optional timer configured to allow for a delayed operation of the visual indicator 126 and/or audible indicator or alarm 128.

The sensing control and measuring circuit also controls a power supply on/off control line to turn on/off the voltage multiplier 113 with the switch 114 and/or voltage clamp 122 which is configured to bring the HV between the electrodes 12 and 14 to ground, faster than allowing the HV caps to gradually discharge through slow draining in an RC time constant decay curve.

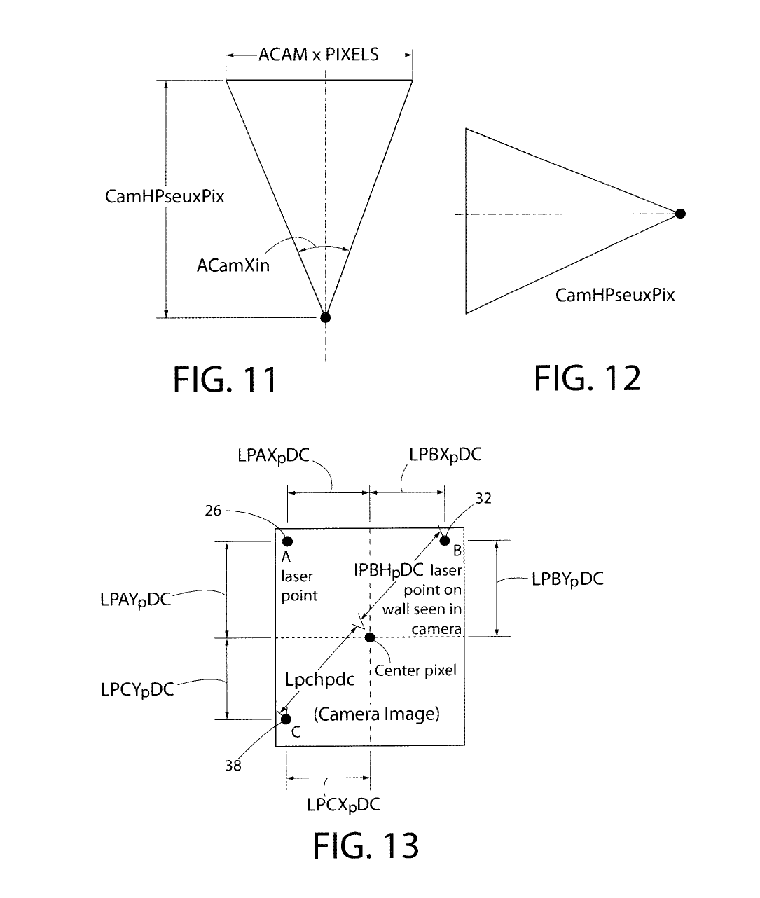

In FIG. 11, the expected max body length and leg length/walking height characteristics of the insect species determines the max size of the spark gaps 300, 302 and 304, which then determines operating voltage. The specie of the insect 2 also determines the configuration of device if it is a floor device or ceiling device.

If the legs of the insect 2 are long and the apparatus 10, 180 or 200 is ceiling mounted, as is best shown in FIG. 12, the insect body hangs substantially lower and further from the electrodes. The gaps 310 and 312 are thus larger than the respective gaps 300 and 302 in FIG. 11, requiring a higher voltage to reach the length down to the insect's body and then back up again.

Some insect species, such as the ‘daddy long legs spider’ (DLLS) have very long legs and hence hang far down, relative to their body size. Others species, such as a centipede, or millipede, have short or very short legs relative to body size. One key consideration in determining or knowing is how far from (above or below) the electrodes the insect's body is when walking (on ceiling or floor) i.e. gravity effects on walking. Although a spider typically has long legs, it's body hangs low to the ground when walking on a floor, but hangs far from a ceiling when walking upside down. An exception to this would be spider mite. Generally, the variation in ant's body distance to walking surface, ground or ceiling, is seen to be less than for spiders.

As illustrated in FIG. 11, the spark gap length being the sum of gap 300 and gap 302 between both ends of the insect 2 and the electrodes 12, 14 must be less than the total gap size 304. The voltage will be set at a level so to not jump the gap 304 unless a conductive object helps bridge the gap.

FIG. 12 illustrates an upside down configuration that requires additional features for effectiveness for generally all insects 2, except those with extremely short legs or strong legs.

A means to effectively compensate for long leg length of the insect 2 in a ceiling application requires an insulating barrier 150, in a form of a raised portion or a bump, preferably midway between electrodes 12, 14. This insulating barrier 150 allows the voltage to be set higher. However, the voltage must be set below the threshold equal to sum of gap 170 and gap 172, that is below the thresholds between the top of the insulating barrier 150 and the respective electrodes. In this way, the insect's body creates smaller gaps 166 and 168 than the effective electrode gap equal to sum of gap 170 and gap 172. Again, the sum of gap 166 and gap 168 must be less than the sum of gap 170 and gap 172 for the apparatus to be effective.

Thus, it has been found that if the insect 2 has very long legs and is on the ceiling, the insulating barrier(s) 150 must be used to increase voltage without discharge to enable effective extermination of similar insect species. In other words, the gap distances to the insect's body must be less than the distances from the end of the electrode to the top of the insulating barrier 150.

FIG. 13 illustrates an embodiment using several sized electrodes with insulating barriers 150 so as to effectively cover a wide range of insect sizes, without going too close to the self-discharge-through-air-with-nothing-present voltage. It must be noted that the leftmost electrode of the 5000 v gap can be combined with or the same as the right most electrode of the 2000V sized electrode, saving copper or aluminum, as long as the polarities alternate ex. + − + − to maintain a voltage difference potential. It must be further noted the voltage must be lower in absence of the insulating barrier 150 between the electrodes 12, 14.

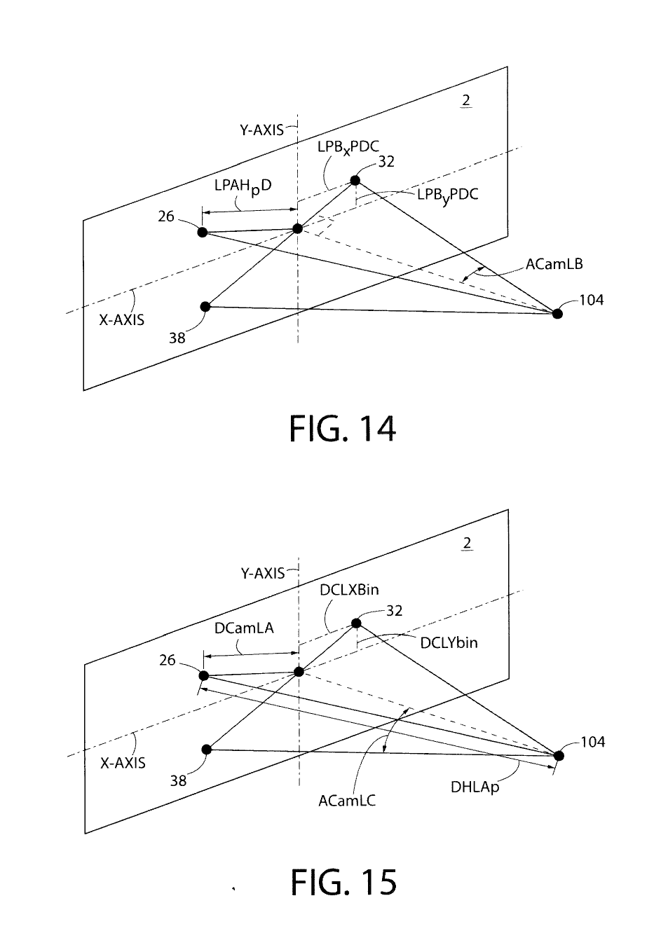

FIG. 14 illustrates an upside down configuration with a shield 11, the shield being the insulating top of the cap, functioning as both a physical/mechanical and electrical shield, and the bottom surface beneath the cap to protect a floor or rug from the insect debris that result from electrocution, the surface being deliberately smooth, non-absorbent, and easy to clean, catch falling electrocuted and dead insects 2 and also a variety of discharge areas to kill insects 2 of a variety of sizes and species.

Insulating barrier or Bump 150 is advantageous for insects 2 with higher leg-length/body length ratio, while a bumpless upside down ceiling unit is effective for species with short legs and a long body, or leg-length/body-length ratio is low. The bump 150 increases the overall spark gap length, said spark originating from one electrode and needing to go up over the insulating bump and back down the other side to the other electrode, rather than straight across, allowing for higher voltages between two electrodes spaced a given distance apart. An insect or pest straddling the bump places its body between the electrodes in its normal movement to climb over it, and the higher voltage is enabled to then spark thru the pest, over the bump and to the other electrode. If the bump 150 were not present, the higher voltage would continuously arc without any pest present rendering the device ineffective. The presence of two or more bumps would easily be counterproductive allowing a pest to use the peaks of the bumps to walk overtop them, much higher and further from the electroces, without getting close enough to cause a discharge, rendering the device ineffective to such insects at times.

FIG. 15 illustrates an approximation of a new virtual spark gap distance calculation based on the geometry of the electrode separation and insulating barrier (bump) height as follows:

$$New\_higher \_voltage \_factor \sim = \frac{sqrt ( {H}_{1}^{2} + {L}_{1}^{2} ) + sqrt ( {H}_{2}^{2} + {L}_{2}^{2} )}{( L 1 + L 2 )}$$

This distance calculation is then used to calculate a new maximum spark gap voltage (using ˜3 kv/mm) which is the approximate breakdown voltage gap vs. distane calculation constant for air at room temperature and sea level. The reader is advised that actual voltage depends on atmospheric pressure (example altitude, barometric pressure, as well as humidity and temperature), in reference to Paschen's Law and the Townsend Breakdown mechanism in gasses.

To avoid being near the breakdown voltage, it is presently preferred to reduce the voltage to 80% of 3 kv/mm and use smaller gaps additionally to cover the 20% size which would otherwise be too small for the insect 2 to trigger the needed discharge.

At 80% of the spark voltage, the insect 2 would be killed up to approximately 20% of the size of the gap distance, even when the electrodes 12, 14 are not very wide.

It has been estimated that a gap of 1 cm derated by 80% would optimally need only a 24,000 volt charge to kill insects 2 up to 8 mm in length.

1 cm at 80% discharge voltage=24000 v(0.8×3000/mm×10 mm/cm=24000 V)

So an 80% limit factor of a 1 cm gap would need a 2nd gap at ˜2 mm of 0.8×3000 v/mm×2 mm=4800 v.

And an 80% limit factor of 2 mm gap would need a third gap of 20% of 2 mm=0.4 mm and a calculated voltage of 0.8×3000/mm×0.4 mm=960 v

In the case of bed insects, a 3 mm gap at 4800 v has been estimated to be effective on a floor based unit. A discharge current between about 50 microamps and about 5,000 microamps has been also found to be quite effective. Insects 2 smaller than 0.6 mm may not be affected and a smaller separate electrode spacing of 0.6 mm @ 1500V may be considered in useful in killing insects 2 down to ˜0.05 mm, based on the above calculations.

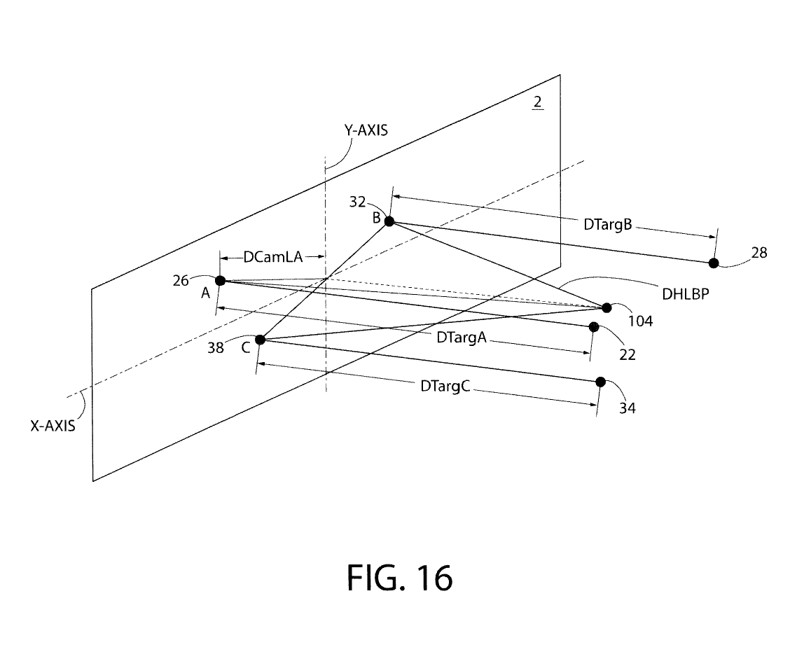

FIG. 16 illustrates an alternative means to using insulating barriers 150 and higher voltages in killing long legged insects or medium length upside down insects by using conductive electrodes 14′ of varying heights. The cost effectiveness varies depending on metal prices, manufacturing prices and lower voltage power supply and insulation prices.

Electrodes of varying heights are contemplated as having a better chance of being close to the belly of a long legged or tall/large insect in ceiling, wall or floor installations, while also simultaneously having a second electrode near another section of the insect body. The advantage of the tall electrode 14′ over a tall insulating barrier 150 is in a lower voltage that can be used with the same effectiveness. However, the cost effectiveness of the added metal and construction may not offset the lower voltage power supply cost. Also this configuration is perceived to be more easily and likely to be damaged when cleaned or bumped.

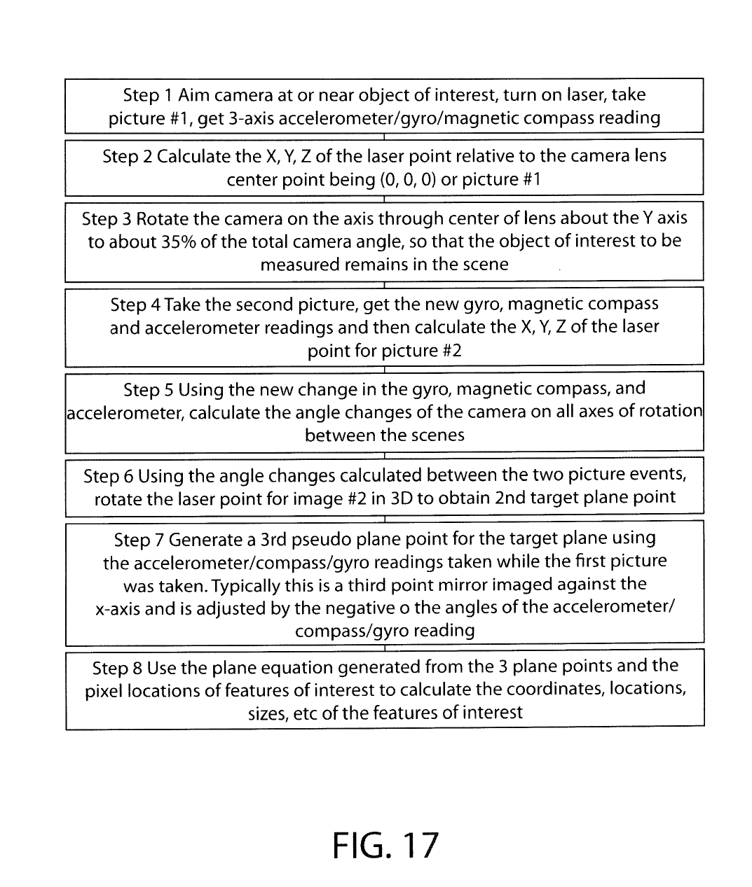

FIG. 17 illustrates a Flowchart of one embodiment of the invention. If there is no indication of movement, the HV power is left on and apparatus is operational. If human or animal movement is detected from the sensors 92, 94 d/or 96, the circuit disables HV power supply to electrodes 12, 14. A waiting period, for example five seconds, is contemplated after movement detection to allow for unusual cases where human or animal motion is stopped but in the vicinity of the electrodes 12, 14. Either or both visual and audible indicators 126, 128 are turned ON during such waiting period to notify that the HV power is about to be reapplied. After the end of the waiting period, the circuit reconnects HV power to the electrodes, 12, 14, thus resuming normal operation. If no movement is detected, normal operation continues.

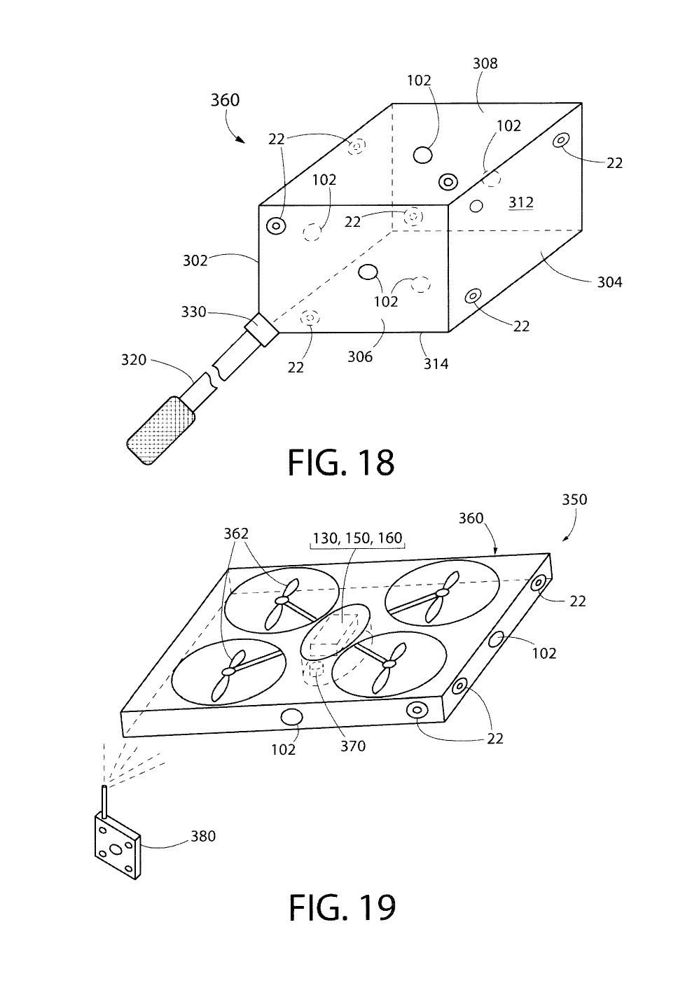

FIGS. 18a-b illustrate front and end elevation views of an optional device 140 to dislodge dead insects 2 from contact with electrical electrodes 12 and 14. By way of one example only, such device 140 operable on a principle of small racecar and including a small concave shape member 142 resembling a conventional plow. The device 140 is operable by connecting LV to electrodes 12, 14 so that dead insect can be moved off the electrodes 12, 14 to, for example, a chamber 144 at one end of the member 30. Thus, in this embodiment, the dead insect 2 is prevented from permanently shorting the electrodes 12, 14 and enabling the apparatus to exterminate additional insects 2. The electrocuted and dead insects 2 can be vacuumed from the chamber 144 when it is convenient for the user of the apparatus. This embodiment is particularly advantageous for the support member 30 being flat or T-shaped.

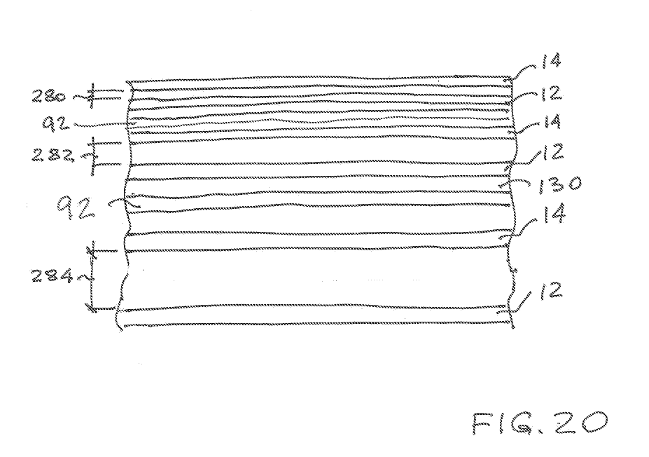

FIG. 19 shows a doorway of any common size and further shows the PIR sensor 94 sensing motion along the apparatus 10 either on one vertical side or both. PIR 94 can have a light source 130 activated to illuminate the apparatus 10, either continuously or only when motion sensed, the light source 130 being visible or ultraviolet for phosphorescent illumination by the strip. This offers added safety at night. The zap power may be left on but the person can safely see it and step over it. Alternatively, a light indicator may be mounted external to PIR.

FIG. 19 further shows two collapsible/expandable telescoping extrusions, one fitting in the other, to enable manual adjustment to fit snugly and exactly inside any size doorway. However, the instant invention contemplates a single member sized to fit the width of the door opening without any adjustments in lengths. A Velcro type fastener or the like is employed for fastening purposes. Any power cords, sensing lines or control lines can be coiled to run inside the extrusions between them invisibly, coiled—extendable similar to telephone headset wire.

It is further noted that since insects are not warm blooded, they are not sensed by the PIR 94, however, warm blooded pets and humans are sensed by the PIR 94. PIR 94, upon sensing human motion, send a signal to the processor 120 that commands the circuit in FIG. 10 to turn off HV, preventing the human from being shocked or before he can be shocked. PIR 94 is preferably coated or THE PIR's outer edges are coated with PFTE Teflon tape to prevent/discourage insects from walking on them (rendering it too slippery to walk on). Although, the vertical portion 10′ is shown as extending only partially in a vertical direction, it can be sized to extend the entire height of the door frame 9 as well as to be placed at the upper edge thereof.

FIG. 20 illustrates an embodiment that is contemplated as a more temporary and economical/portable embodiment using only a modified, thin Velcro® strip 130 as the base to mount electrodes 12, 14 on, rather than a thicker pair of telescoping extrusions seen in FIG. 19.

Embodiment of FIG. 20 is similar to embodiment of FIG. 19, but substitutes a male velcro backed flat strip 130 (and an optional self adhesive peel-and-stick edge on one or both sides to adhere to a wall or ceiling or also attaching better to a rug on the edges) for the FIG. 19 mushroom shaped extrusion embodiment which is more solid, less flexible, larger, heavier, more rugged, easily made safer.

The reader is also advised that embodiment of FIG. 19, and many mushroom shaped embodiments disclosed herein, have electrodes positioned above and below the insects head, sending current through the head first, rather than the whole body which can occasionally bypass the head and prove less effective, especially with larger insects such as centipedes or roaches which may hold their head higher. Each embodiment of FIGS. 19-20 is contemplated to be adapted with PIRs 94 at either end and power supplies and the safety sensing circuit logic of FIG. 10 as described above.

At the top of FIG. 20, the electrodes 12, 14 are shown as spaced closer to each other by a small gap 280 so as to electrocute smaller insects 2, while at the bottom of FIG. 20, the gap 284 is much larger so as to electrocute larger insects 2, while gap 282 in the middle of FIG. 2 may be sized for insects 2 of a medium size, thus accommodating a wide range of insect sizes.

FIG. 20 also shows optional capacitive/proximity sensor strips 92 as an added and/or separate safety feature means in addition to or instead of the PIRs. It will be understood that the embodiment of FIG. 20 may be placed in the above referenced door way 9 in a manner similar to the embodiment of FIG. 19. It will be further understood that the embodiment of FIG. 20 is equipped with or connected to the above described power jack 102, and the circuit of FIG. 10.

The enhanced velcro strip 130 in FIG. 20 easily rolls up and is typically a maximum of 2× the thickness of a standard velcro strip. It may have a narrow region of female velcro on the opposite top side to enable it to self adhere as it is being rolled up or unrolled for greater convenience. The strip 130 may further have a multi-electrode plug in the middle of it, enabling an extension strip to be inserted in the middle to inexpensively extend the length of effective insect killing area length further. The PIR 94 may also point downward to effectively sense human or animal presence around or below it, This pointing down is atypical for PIR operation, and is generally seen as less safe or more difficult to make safe. In this case only 1 PIR/safety/power assembly is needed on only 1 side. It should be noted the bottom of the velcro strip 130 may only be a self adhesive strip or a plain plastic strip which is attached to a double-sided adhesive tape to adhere the strip to a rug, floor or wall. This is contemplated as a less expensive but less convenient to quickly setup or remove.

Instant invention provides for tripping hazard safety, especially at night. The glow in the dark luminescent and or phosphorescent capability is important. Alternative light indicators may be also used.

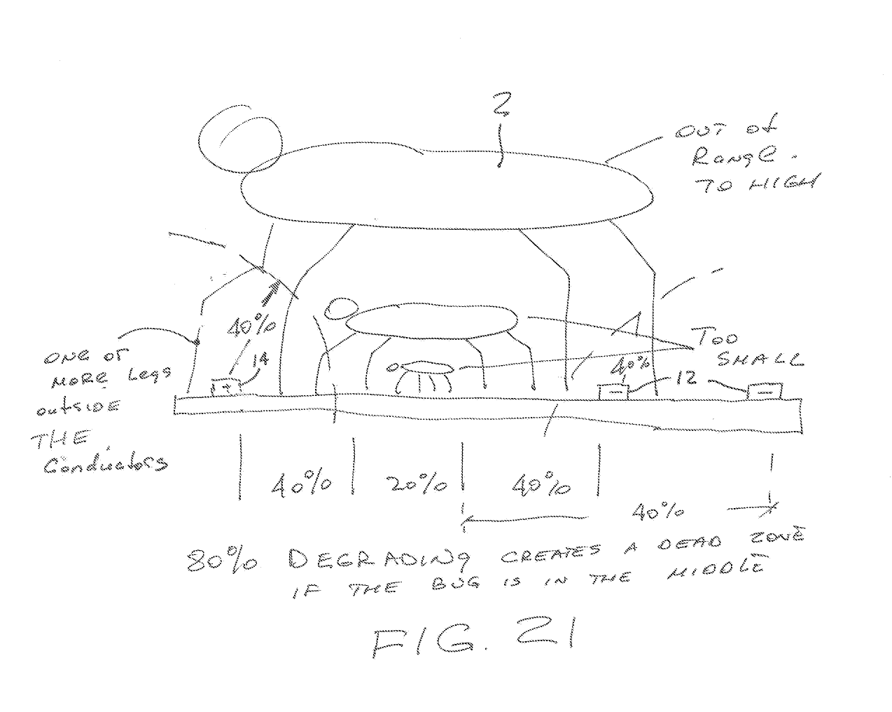

FIG. 21 illustrates a need for gap between electrodes 12, 14 and voltage to be sized to accommodate insect size and shows insects of a three different sized and further applying a 20°-80% rule with a 40% “bubble circle” around both electrodes, so the middle size insect looks is clearly outside of range. The body of the insect 2 needs to be inside both bubbles to be zapped. Right side of FIG. 21 also illustrates that the bubble location moved for the new position of the insects relative to the electrodes and the 80%-20% voltage with the 20% zone being also moved.

If the mid sized insect 2 were longer or it's legs were shorter or a specific combination of the two, the insect would be zapped, so the 40% semicircles or “bubble circle” shows this graphically in FIG. 21.

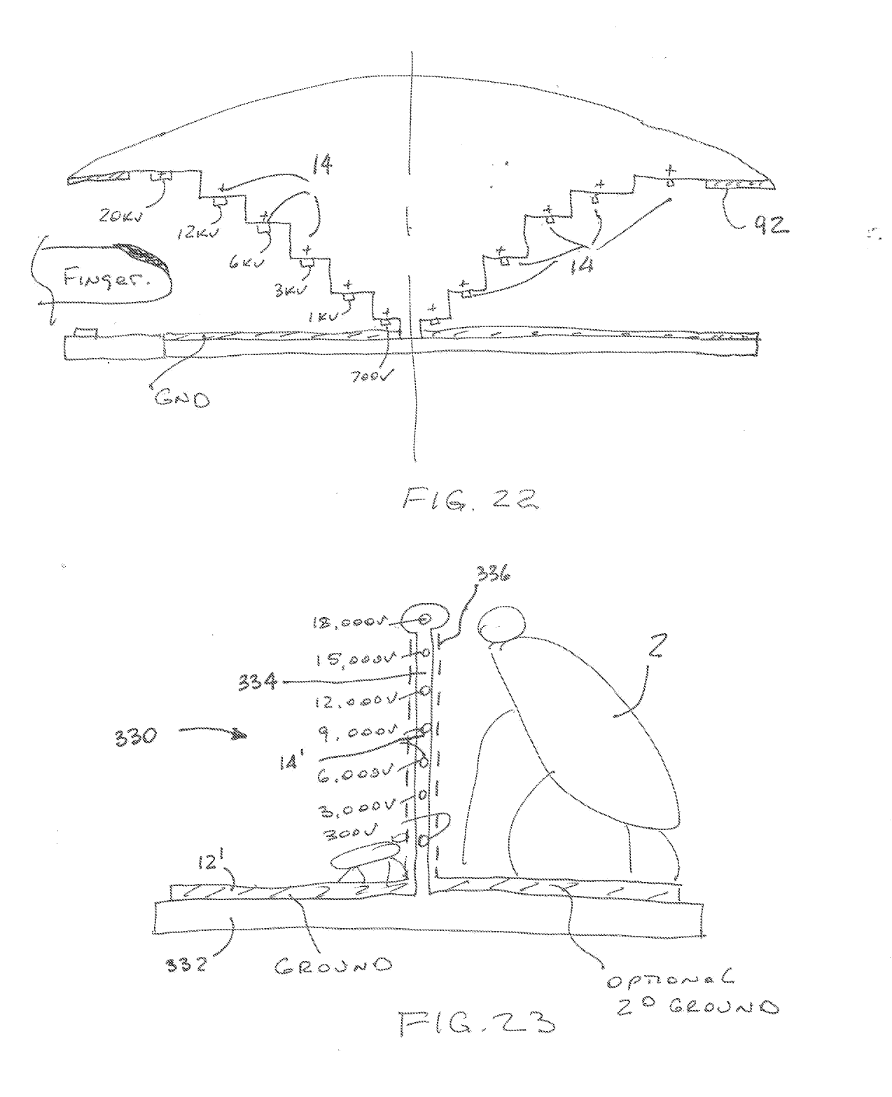

FIG. 22 illustrates an arrangement of staggered positive electrodes 14 configured for different voltages so as to kill all size insects in the support member being of a mushroom shape. Also shown is an optional capacitance plate 92. Further shown is a finger of a person changing the capacitance from 1 pf to 5 pf with it's presence.

Furthermore, it is currently preferred to have the current go through the head of the insect 2, more than the body, so FIG. 22 not only accommodates a wider variety of insect sizes in the mushroom shaped embodiment, but encourages the current to flow through the head from below to above it, rather than across the body length, possible missing the head if the head is held high as in some species.

FIG. 23 illustrates an alternative embodiment of T-shaped member, generally designated as 330, having a base 332 with the electrode 12′ mounted on or therewithin and a plurality of electrodes 14′ mounted in a vertically disposed member 334. and the plurality of electrodes are sized for and are connected to different voltages so as to accommodate insects of different sizes. A small insect 2 gets electrocuted with a lower voltage small arc or spark at base of unit, while a large insect 2 receives large voltage, resulting in the apparatus configured to electrocute insects 2 of various sizes. It must be noted that if the high voltage were near the ground it would arc over continuously and would not work.

Furthermore, a thin cover 336 manufactured from an insulating material such as Teflon® or any other suitable materials, over the surface of surfaces of the vertical member 334 helps in cleaning efforts and may further impede insect movement due to low friction characteristics. The reader is advised that Teflon cover 336 does not cover ground electrodes 12′ which may be used to power the motorized collecting vehicle 140 of FIGS. 18a-b when the insect 2 has been electrocuted and killed. One of the ground electrodes 12′ will be switched to low voltage, high current mode during car operation, and switched back to ground after the collection operation is completed.

This embodiment also serves to offer the vertical section 336 of the extrusion as a guidance track means to guide a collection vehicle 140 along the track and the ground electrodes illustrated in the figure also can automatically be switched to a positive or negative low voltage high current source to power the vehicle and control its forward or reverse motion as it goes along the track to dispose of the remains. Finally, this alternative embodiment with an optional Teflon® coating or cover 336 also will function as a slippery tractionless deterrent and barrier to some degree even if the power goes off.

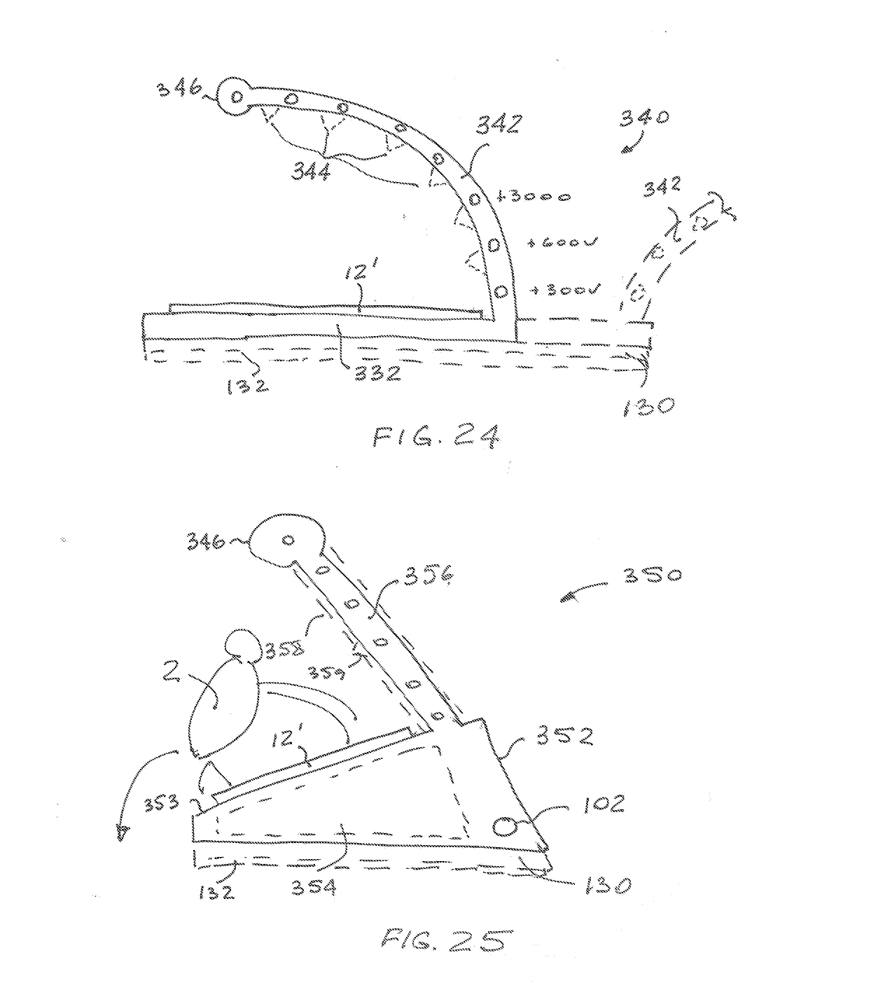

FIG. 24 illustrates a modified form of FIGS. 22-23, particularly illustrating a support member, generally designated as 340, having a member 342 arched in a direction of approach of the insect 2. The arched member 342 is adapted with electrodes in a pattern of FIGS. 22 and 23. The arched member 342 may be further adapted with optional ridges 344 on an inner surface thereof to facilitate use of the support member 340 in applications associated with moisture, for example such as rain. It is important to extend the base 332 past the left most point 346 in FIG. 24, so as to assure that the insect 2 is bridging electrodes 12′, 14′ of different polarities. An optional second arched member 342 may be also provided and arching in a direction opposite from the first member 342.

FIG. 25 illustrates another modified form of FIGS. 22-23, particularly illustrating a support member, generally designated as 350, having a base 352 with an inclined surface 353 having the electrode 12′ mounted thereon or therewithin. The base 352 may be hollow by way of cavity 354. The support member 350 further includes a member 356 disposed generally (within an acceptable tolerances) perpendicular to the surface 353. The member 356 is adapted with electrodes in a pattern of FIGS. 22 and 23. The member 356 may be further adapted with protective cover 358 and optional ridges 359 on an inner surface thereof to facilitate use of the support member 350 in applications associated with moisture, for example such as rain. It is important to extend the base 352 past the left most point 346 in FIG. 25, so as to assure that the insect 2 is bridging electrodes 12′, 14′ of different polarities. It is contemplated that inclined position of the member 356 facilitates movement of the electrocuted insects 2 away from electrodes 12′, 14′.

Either form of FIGS. 24-25 illustrates employment of a Velcro® fastener 130 and a peel cover 132, that can be employed with fastener 130 in any of the above described and shown embodiments.

The instant invention also contemplates that electrocuted and dead inspects 2 can be collected with a robotic vacuum device (not shown), controlled from the control circuit of FIG. 10 for travel along the electrodes 12, 14 of FIGS. 1-4.

The instant invention further contemplates that electrocuted and dead inspects 2 can be incinerated by way of a built-in incinerator in the CSP. Such embodiment would require a power of about a 140 watt soldering iron for about 1 minute to accomplish this. This could be done upon return to the base home position of the CSP where higher current contacts can be engaged to power an internal incinerator, not the low power contacts in the strip to move the CSP only.

Although, the instant invention has been described in combination with electrocution of insects, it would be easily understood that any of the above described embodiments can be used for electrocuting rodents, such as mice, rats, etc, reptiles, such as snakes and the like, scorpions, tarantulas and the like larger species.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. An apparatus comprising:
a support member including a base portion and another portion upstanding on one surface said base portion; and
electrodes mounted on a surface or embedded into a thickness of said each base portion and said another portion of said support member and electrodes connectable to a source of electric power, said electrodes are mounted an sized so as to cause the insects bridging said electrodes to receive a current when said electrodes are connected to the source of electric power.

2. The apparatus of claim 1, wherein said another member includes a plurality of electrodes and wherein each electrode is connected to a unique voltage.

3. The apparatus of claim 2, wherein said unique voltage progressively increases in value in a direction from said surface of said base portion toward a free end of said another portion.

4. The apparatus of claim 1, further comprising said power source and a control circuit operable to at least couple operating voltage to said electrodes and decouple said operating voltage therefrom.

5. An apparatus comprising:
(a) a support member including:
i. a base portion having a pair of generally planar surfaces spaced apart from each other to define thickness of said base portion,
ii. a cap portion having a concave inner surface spaced apart from an inner surface of said base portion and a convex outer surface defining each of a thicker middle region and a pair of generally thin outer edge regions of said cap portion, and
iii. a middle portion disposed mediate and joining said base and cap portions along length thereof, said middle portion being sized so as to position each of said pair of outer edges of said cap portion at a distance away from said inner surface of said base portion;
(b) a pair of electrodes connectable to a source of electric power, said pair of electrodes being disposed in a spaced apart relationship with each other on a surface or within a thickness portion of said support unitary one-piece member, said spaced apart relationship is so configured as to cause the insects bridging said pair of electrodes to receive a current as a function of their internal resistance when said pair of electrodes are connected to the source of electric power;
(c) wherein said distance is sufficiently sized so as to permit insects to reach said pair of electrodes and prevent insects from climbing onto said exterior surface of said cap portion; and
(d) wherein said apparatus is configured to at least substantially prevent or eliminate direct contact of humans, household pets and animals with said pair of electrodes.

6. The apparatus, according to claim 5, wherein said pair of electrodes are disposed on said inner surface of said base portion or electrodes are at least partially imbedded into said thickness of base portion.

7. The apparatus, according to claim 5, wherein said middle portion includes at least one aperture formed through a thickness thereof.

8. The apparatus, according to claim 5, wherein said pair of electrodes are disposed to one side of said middle portion and wherein said apparatus further includes another pair of electrodes disposed to an opposite side of said middle portion.

9. The apparatus, according to claim 5, wherein said middle portion includes a channel extending a length of said middle portion in open communication with a surface thereof and wherein each of said pair of electrodes is positioned at a juncture of said surface of said middle portion and a wall of said channel.

10. The apparatus, according to claim 5, wherein said middle portion includes a pair of channels extending a length of said middle portion in open communication with a respective surface thereof, wherein said apparatus further includes an additional pair of electrodes and wherein each electrode is positioned at a juncture of said respective surface of said middle portion and one wall of a channel.

11. The apparatus of claim 5, further including means for releaseably connecting said middle portion to said base portion.

12. The apparatus of claim 11, wherein said means includes an abutment disposed on an end of said middle portion along a length thereof and a channel formed in said inner surface of said base in open communication thereof, said channel being configured to releaseably receive said abutment.

13. The apparatus of claim 5, further including means for detecting a presence of humans, household pets or animals.

14. The apparatus of claim 13, wherein said presence detection means is a sensor positioned on said support member or in a proximity thereto.

15. An apparatus comprising:
(a) a support member having a pair of generally planar surfaces spaced apart from each other to define thickness of said support member; and
(b) electrodes connectable to a source of electric power and disposed in pairs with a unique spacing therebetween on a surface or within a thickness portion of said member, said unique spacing is configured so as to cause the insects bridging any pair of electrodes to receive a current as a function of their internal resistance when said electrodes are connected to the source of electric power.

16. The apparatus of claim 15, further comprising a sensor positioned to detect presence of insects, humans, household pets and animals.

17. The apparatus of claim 15, further including a fastener disposed on one surface of said member.

18. An apparatus comprising:
(a) a support member including:
i. a generally planar base surface,
ii. a first side surface inclined relative to said base surface,
iii. a second side surface inclined relative to said base surface,
(b) a first pair of pair of electrodes connectable to a source of electric power, said first pair of electrodes being disposed in a first spaced apart relationship with each other on said first surface or within a thickness portion of said member in close proximity to said first surface, said first spaced apart relationship is configured so as to cause the insects bridging said first pair of electrodes to receive a current when said first pair of electrodes are connected to the source of electric power; and
(c) a second pair of pair of electrodes connectable to a source of electric power, said second pair of electrodes being disposed in a second spaced apart relationship with each other on said second surface or within a thickness portion of said member in close proximity to said second surface, said second spaced apart relationship is configured so as to cause the insects bridging said second pair of electrodes to receive said current when said second pair of electrodes are connected to the source of electric power.

19. The apparatus of claim 18, further including an abutment upstanding on a juncture of said first and second side surfaces, said abutment configured to facilitate movement of insects received said current from said first and second side surfaces.

20. The apparatus of claim 18, further including an aperture formed through a length of said member.
